(19) United States
(12) Patent Application Publication
(10) Pub. No.: US 2024/0275832 A1
(43) Pub. Date: Aug. 15, 2024

(54) METHOD AND APPARATUS FOR PROVIDING PERFORMANCE CONTENT

(71) Applicant: ELECTRONICS AND TELECOMMUNICATIONS RESEARCH INSTITUTE, Daejeon (KR)

(72) Inventors: Yong Wan KIM, Daejeon (KR); Ki Hong KIM, Daejeon (KR); Jin Sung CHOI, Daejeon (KR)

(21) Appl. No.: 18/522,882

(22) Filed: Nov. 29, 2023

(30) Foreign Application Priority Data
Feb. 13, 2023 (KR) 10-2023-0018927

(51) Int. Cl. H04L 65/60; G06F 3/01; G06F 9/54; G06T 15/00

(52) U.S. Cl. CPC H04L 65/60; G06F 3/017; G06F 9/547; G06T 15/005

(57) ABSTRACT

Provided is a method of operating a rendering server. The method includes identifying at least one object from image information, generating a rendered image for the at least one object, transmitting the rendered image to be displayed on a user terminal, extracting at least one piece of event information corresponding to a specific time period from the image information, and providing the at least one piece of event information to a host server to be synchronized according to the specific time period.

### CROSS-REFERENCE TO RELATED APPLICATION

This application claims priority to and the benefit of Korean Patent Application No. 10-2023-0018927, filed on Feb. 13, 2023, the disclosure of which is incorporated herein by reference in its entirety.

### BACKGROUND

### 1. Field of the Invention

The present disclosure relates to a technique for providing performance content, and more specifically, to a content provision technique for providing virtual performance content including interactions between users to a plurality of remote user terminals at a certain level of quality.

### 2. Description of Related Art

Recently, in line with the Coronavirus disease 2019 (COVID-19) pandemic, various types of performance agencies are presenting online digital performances that combine information and communications technology (ICT) such as virtual reality (VR) and augmented reality (AR) to the public and are actively attempting unprecedented online profit models.

Online digital VR performances with a large number of people participating in the form of avatars in online virtual spaces are being presented, and market demand for digital humans expressing natural emotions at a photorealistic level is increasing.

Currently, it is difficult to express natural digital humans at a photorealistic level in mobile terminals due to a lack of computing power or the like. Further, even in the case of VR video streaming serviced as 360 video, there are restrictions on the freedom of viewpoints and since VR video streaming is video-based, it is difficult to expect real-time interactions between users participating in a performance.

In the future, for virtual online performances in the form of a metaverse, there is an increasing need for services that allow performers with meta-human quality at a photorealistic level provided by Unreal Engine or the like and large audiences to indirectly participate in performances.

However, it is technically difficult to guarantee quality of a certain level or more for such high-quality virtual performance content on a plurality of client mobile terminals remotely accessed thereto.

### SUMMARY OF THE INVENTION

The present disclosure is directed to providing a method of visualizing a high-quality performance in real time and enabling interactions between audience members even on a plurality of remote user terminals.

More specifically, the present disclosure is directed to providing a structure of a dual object-specific streaming-multi-play host server in which a multi-play host server for individually rendering, encoding, and streaming a high-quality performer avatar in a video format using high-performance server resources, synthesizing and synchronizing a result of the rendering, encoding, and streaming with a scene on a client-side mobile device, and supporting audience free navigation and interactions between audience members even in a streaming environment is supported.

According to an aspect of the present disclosure, there is provided a method of operating a rendering server, including identifying at least one object from image information, generating a rendered image for the at least one object, transmitting the rendered image to be displayed on a user terminal, extracting at least one piece of event information corresponding to a specific time period from the image information, and providing the at least one piece of event information to a host server to be synchronized according to the specific time period.

The image information may be extracted from performance content and may be visually identifiable information.

The at least one object may be at least one performer participating in the performance content.

The at least one piece of event information may be provided to the host server through a remote procedure call (RPC).

The method may further include obtaining depth information corresponding to the rendered image, generating encoded data packed according to a predetermined format on the basis of the rendered image and the depth information, and providing the encoded data to a media server.

The method may further include obtaining location information of the user terminal, wherein the at least one piece of event information is synchronized according to the location information.

The at least one piece of event information may include transform data for at least one of background information and audience information that are extracted from the image information, the background information may include information on at least one of special effects, an animation, and an object of the image information, and the audience information may include information on at least one of a location, a gesture, and an interaction of a user of the user terminal.

According to another aspect of the present disclosure, there is provided an apparatus of a rendering server, including a transmission and reception unit, and at least one control unit operably connected to the transmission and reception unit, wherein the at least one control unit is configured to identify at least one object from image information, generate a rendered image for the at least one object, transmit the rendered image to be displayed on a user terminal, extract at least one piece of event information corresponding to a specific time period from the image information, and provide the at least one piece of event information to a host server to be synchronized according to the specific time period.

The image information may be extracted from performance content and may be visually identifiable information.

The at least one object may be at least one performer participating in the performance content.

The at least one piece of event information may be provided to the host server through an RPC.

The at least one control unit may be further configured to obtain depth information corresponding to the rendered image, generate encoded data packed according to a predetermined format on the basis of the rendered image and the depth information, and provide the encoded data to a media server.

The at least one control unit may be further configured to obtain location information of the user terminal, and the at least one piece of event information may be synchronized according to the location information.

The at least one piece of event information may include transform data for at least one of background information and audience information that are extracted from the image information, the background information may include information on at least one of special effects, an animation, and an object of the image information, and the audience information may include information on at least one of a location, a gesture, and an interaction of a user of the user terminal.

According to still another aspect of the present disclosure, there is provided a system for providing an online performance service, including a media server, a host server, and a user terminal, wherein the media server is configured to identify at least one object from image information, generate a rendered image for the at least one object, transmit the rendered image to be displayed on a user terminal, extract at least one piece of event information corresponding to a specific time period from the image information, and provide the at least one piece of event information to a host server to be synchronized according to the specific time period, the host server is configured to obtain the at least one piece of event information from the media server, synchronize the at least one piece of event information according to the specific time period to generate event data, and provide the event data to the user terminal, and the user terminal is configured to obtain the rendered image from the media server, obtain the event data from the host server, and display the rendered image and the event data according to the specific time period.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating hardware components of a performance content provision system according to an embodiment of the present disclosure;

FIG. 2 illustrates detailed configurations of apparatuses constituting a performance content provision system according to an embodiment of the present disclosure;

FIG. 3 illustrates an implementation example in which a performance content provision system according to an embodiment of the present disclosure performs rendering processing for each performer;

FIG. 4 illustrates an implementation example of an operation in which a performance content provision system according to an embodiment of the present disclosure encodes a viewpoint texture and a depth texture for each performer;

FIG. 5 illustrates an implementation example in which a performance content provision system according to an embodiment of the present disclosure performs decoding and mesh deforming processing on a viewpoint texture and a depth texture for each performer;

FIG. 6 illustrates an example in which a performance content provision system according to an embodiment of the present disclosure allows audience gesture information to be implemented on a user terminal;

FIG. 7 illustrates an example in which a performance content provision system according to an embodiment of the present disclosure develops performance content over time; and

FIG. 8 is a flowchart of an operation of a performance content provision system according to an embodiment of the present disclosure.

### DETAILED DESCRIPTION OF EXEMPLARY EMBODIMENTS

Phrases such as “in some embodiments” and “in one embodiment” that appear in various places in this specification do not necessarily both refer to the same embodiment.

Some embodiments of the present disclosure may be represented by functional block components and various processing operations. Some or all of these functional blocks may be implemented in a variety of numbers of hardware and/or software components that perform specific functions. For example, functional blocks of the present disclosure may be implemented by one or more microprocessors, or may be implemented by circuit configurations for a predetermined function. Further, for example, the functional blocks of the present disclosure may be implemented in various programming or scripting languages. The functional blocks may be implemented as an algorithm running on one or more processors. Further, the present disclosure may employ conventional techniques for electronic environment setting, signal processing, and/or data processing. Terms such as “mechanism,” “element,” “means,” and “configuration” may be used broadly and are not limited to mechanical and physical components.

Further, connection lines or connection members between components illustrated in the accompanying drawings are merely examples of functional connections and/or physical or circuit connections. In an actual apparatus, connections between components may be represented by various replaceable or additional functional connections, physical connections, or circuit connections.

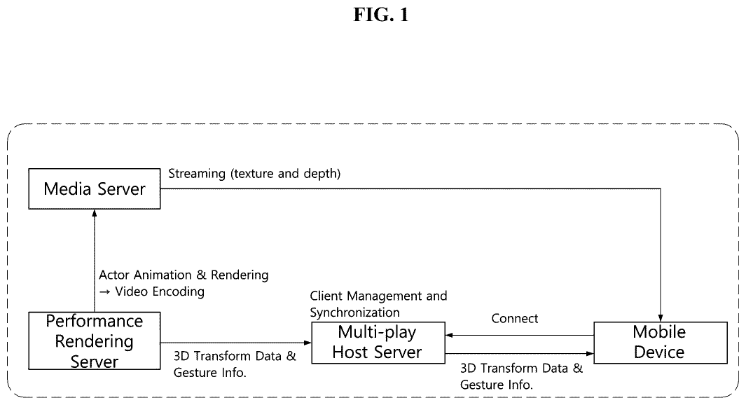

FIG. 1 is a block diagram illustrating a hardware configuration of a performance content provision system according to an embodiment of the present disclosure.

Specifically, a content provision system may be a system used to generate or provide performance content, and a performance may be an artistic act provided to an audience by a performer using his or her knowledge, skills, or abilities.

Referring to FIG. 1, the performance content provision system according to the embodiment of the present disclosure may be largely composed of four main components. More specifically, the performance content provision system may include a performance rendering server, a media server, a host server, and a user terminal.

The performance rendering server may render performance content on a per-performer basis using high-performance server resources, encode the rendered data in a video format, and transmit the encoded data to the media server.

The performer may be, for example, an actor or a player, and specifically, may be at least one of performers who speak, act, or play in a specific scene.

The rendering on a per-performer basis may include an operation of identifying at least one performer by distinguishing the performer from other background elements. Therefore, the performance rendering server may identify or extract an area corresponding to the at least one performer from performance content and then individually perform a rendering operation on the identified or extracted area.

The media server may receive the encoded data from the performance rendering server and provide the data to the user terminal. Here, the media server is a component independent from the performance rendering server, and may be configured to transmit or receive signals or data to or from the performance rendering server or may be one apparatus included in the performance rendering server.

The media server may provide the encoded data to the user terminal in a way that provides a streaming service.

The user terminal may unpack a result streamed from the media server and visualize the unpacked result in the form of a deformed sprite.

The user terminal may be a mobile device such as a mobile phone, a head mounted display (HMD), etc. of an audience member watching a performance. The audience may obtain performance content through their user terminals. Specifically, the user terminal may obtain and display performance content, which is generated by extracting and reprocessing a specific performer, from the media server.

The host server may obtain transform data such as an event, a performer, an audience, etc., audience gesture information, and the like from the performance rendering server, and synchronize the transform data or manage the user terminal. The host server may be referred to as a multi-play host server.

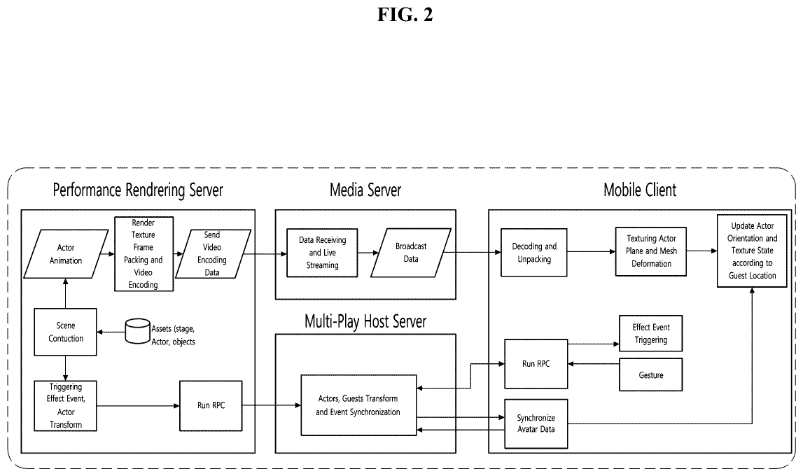

FIG. 2 illustrates detailed configurations of apparatuses constituting a performance content provision system according to an embodiment of the present disclosure.

Referring to FIG. 2, a performance rendering server may configure a scene using assets (stages, performers, objects, etc.). That is, the performance rendering server needs to configure the scene so that the performance content provision system can individually perform server rendering for each performance element, such as a performance stage, a performer, a viewing space, and the like in advance.

Here, setting of rendering quality, resolution, frames per second (fps), etc. for a performance stage, a group object, performers, etc. that constitute a scene may be performed at this stage. The performance rendering server may process the configured scene to be natural movements of each performer using high-performance server resources, and individually perform rendering for various viewpoints. In this case, a process of packing information, including individual rendering results and depth information, in a target video format may be performed. Further, the information may be packed in a target format suitable for transmission, and source compression suitable for a network transmission bandwidth may be performed to perform fast transmission even in various network environments.

The performance rendering server may transmit the compressed encoded video data to a media server. In this case, the compressed encoded video data may be transmitted through a wired or wireless network.

The media server may provide a real-time video service that can generate live output for video broadcast and streaming transmission using the compressed encoded video data received from the performance rendering server, and may convert a format and package of real-time video content into other formats and packages.

The reason why the content is converted is to provide formats and packages that can be processed by playback devices such as various mobile devices. An unpacking process may be performed on a frame-by-frame basis by performing decoding on the converted and received streaming video. Textures to be applied to individual performers may be separated through the unpacking process, the separated textures may be textured on the performer's flat mesh similar to a sprite, and then the flat mesh may be deformed using the unpacked depth information.

In parallel, the performance rendering server may connect event information of the performance (performance effects such as fireworks and the like) with the multi-play host server through a remote procedure call (RPC). The RPC may be inter-process communication that allows remote functions or procedures to be executed in a different address space without separate coding for remote control. The multi-play host server may transmit the event to participating mobile clients that are connected to the multi-play host server so that the event can be triggered at the same timing.

Here, the event information may include information on surrounding effects and the like related to the performance. For example, the event information may be understood as including information on the audience, such as movements, gestures, responses, shouts, and the like of the audience, or including all pieces of information on recognizable situations that occur in connection with the performance, such as special effects and the like that occur during the performance.

The multi-play host server may also serve as a communication relay for synchronization between audience avatars to the mobile clients. Further, transformation information or the like of the performer due to a location change caused by animation or the like may also be updated in each mobile client through the multi-play host server. Data such as navigation, transformation changes, gesture information, and the like of the audience members may also be relayed and synchronized between the mobile client terminals through the multi-play host server.

Lastly, a process of changing a texture state to the viewpoint position to provide the performer's appearance as natural as possible even during continuous position movements when an orientation (LookAt) of the performer expressed on the mobile device according to the location movement of the audience member within the mobile client is subtly turned and the performer approaches a predefined viewpoint may be performed.

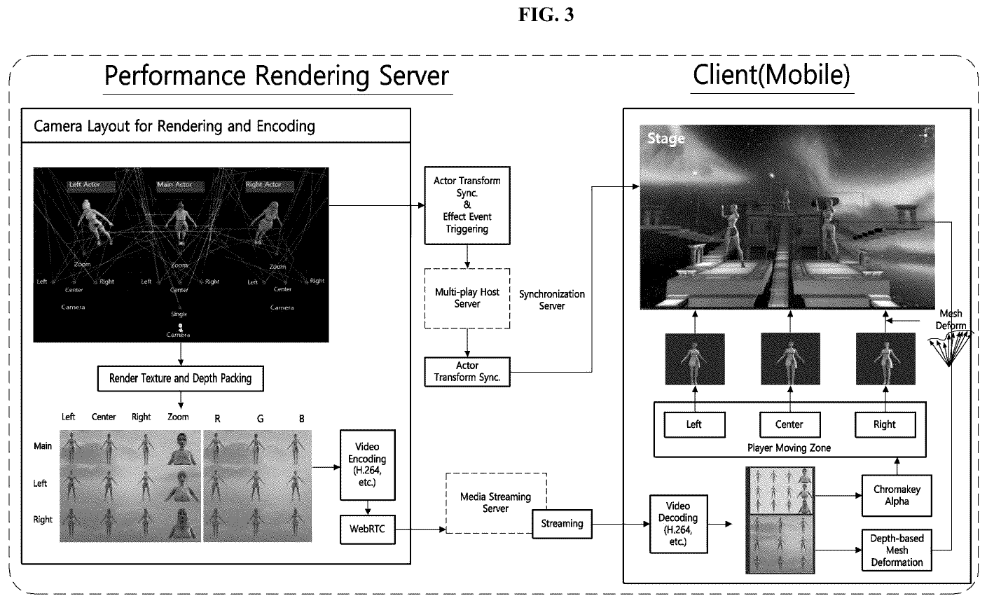

FIG. 3 illustrates an implementation example in which a performance content provision system according to an embodiment of the present disclosure performs rendering processing for each performer.

Referring to FIG. 3, three camera viewpoints (“Left,” “Center,” and “Right”) and an additional viewpoint (Zoom) looking at three performers (left, main, and right actors), respectively, may be set, and as soon as a performance starts, the animated performer's appearance may be rendered from a preset camera viewpoint and stored as a texture. This process is performed at runtime and is called a render texture, and a server-level resource may be required to perform this process simultaneously from multiple viewpoints.

The render texture is a special type of texture that is generated and updated at runtime, and when using the render texture, there is an advantage of using the material's render texture like a normal texture because an area may be set on a canvas and a scene shown in the camera view may be rendered in this area.

Further, a depth texture may be generated during this process. A packing process in which the textures generated in this way are arranged on one video frame according to a target video format may be performed. A process of encoding the texture video frame in a video format such as H.264 or the like may be performed, and a result of the encoding may be transmitted to the media server through a protocol such as Web Real-Time Communication (WebRTC).

WebRTC stands for Web Real-Time Communication, and may allow real-time communication to be provided on the web and in apps (Android or iOS) using cameras, microphones, etc., without software. A WebRTC media server may mean a server that serves to mediate and distribute WebRTC-based media streams, and in particular, Instagram Live, YouTube Live, Twitch, etc. use Real-Time Messaging Protocol (RTMP) for real-time streaming, but the WebRTC has lower latency than RTMP and enables streaming communication similar to real-time with almost no delay, and thus the WebRTC may be a protocol suitable for a performance streaming environment of the present disclosure in which the audience can participate.

A mobile client may perform a process of decoding a video to convert (decode) the video into a collection of frame-by-frame textures and dividing (unpacking) the collection of frame-by-frame textures into individual performers. The mobile client may load a viewpoint texture for each performer and apply the loaded viewpoint texture for each performer to a performer's flat mesh. Thereafter, a process of deforming the flat mesh using depth texture information may be performed to express the natural appearance of the performer. The depth information transmitted from the server may be a brightness value corresponding to the performer's depth information for each viewpoint, and thus this process is a process of deforming vertices in each corresponding flat mesh in the viewpoint direction and may be referred to as a type of mesh warping.

At the same time, a performance rendering server may receive performer transform data through a multi-play host server (serving to perform synchronization on transformation data or the like). An orientation of the performer mesh that best suits the location is updated using the performer transform data and the transform data according to the audience location, and when it is usually set to face the audience and a change to a specific viewpoint position (e.g., “Left”→“Center”) is required, a texture change (“Left”→“Center”) is also performed.

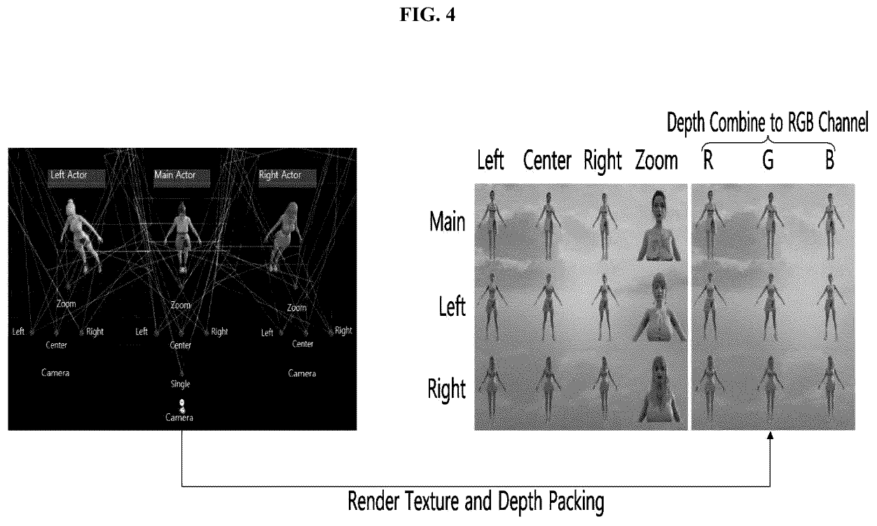

FIG. 4 illustrates an implementation example of an operation in which a performance content provision system according to an embodiment of the present disclosure encodes a viewpoint texture and a depth texture for each performer.

Referring to FIG. 4, a total of 12 color render textures and nine depth textures for each viewpoint may be generated according to three camera viewpoints (“Left,” “Center,” and “Right”) and an additional viewpoint (Zoom) looking at three performers (left, main, and right actors), respectively. In this case, a data value that applies physically-based rendering and reflects the characteristics of the object for reflectance BRDF according to the locations of the observation point and light source may be applied. In the case of nine depth textures, the data value may be considered to be a single brightness, and thus it is possible to prevent the video format from growing as much as possible by assigning and packing the data value to each red, green, or blue (RGB) channel for efficiency.

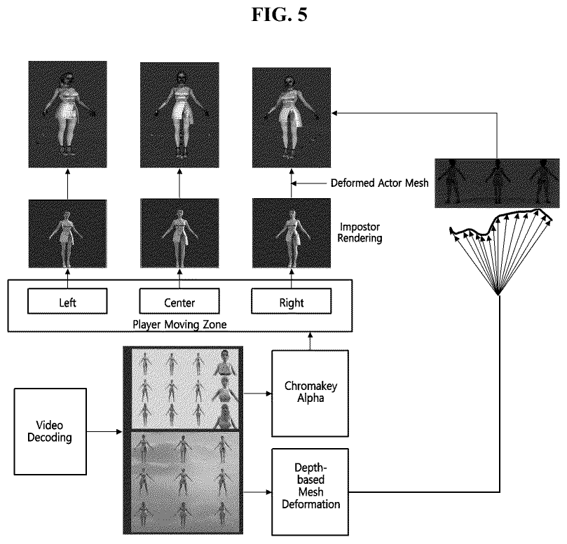

FIG. 5 illustrates an implementation example in which a performance content provision system according to an embodiment of the present disclosure performs decoding and mesh deforming processing on a viewpoint texture and a depth texture for each performer.

The performance content provision system may decode video data received in a streaming format such as H.264 or the like, and then, in the case of a color render texture, the performance content provision system may use a chroma key shader to transparently process areas other than the performer in the frame and manage the areas separately for each performer. The performance content provision system may separate the performance content into a color render texture and a depth texture, and then allow the color render texture to be individually applied as a viewpoint texture for each performer, and in the case of depth texture, the performance content provision system may perform a process of unpacking the information assigned to each RGB channel to generate an individual depth texture. The performance content provision system may apply the color texture for each performer's viewpoint to the flat mesh and deform the color texture using the individual depth texture, according to the audience's relative location (“Left,” “Center,” and “Right” within the player moving zone) to the performer. The reason why the deformation is performed using the individual depth texture for each performer is that the shape of the performer mesh seen from one viewpoint is not in full three-dimensional (3D) form, and thus the performer mesh is deformed to be as similar as possible to the performer mesh of the server using the individual depth texture corresponding to that possible viewpoint. Accordingly, the performance content provision system may perform orientation correction (LookAt) of the performer mesh according to the subtle positional movement of the audience to minimize the possibility that unrestored mesh parts that should not be visible are visible to the audience.

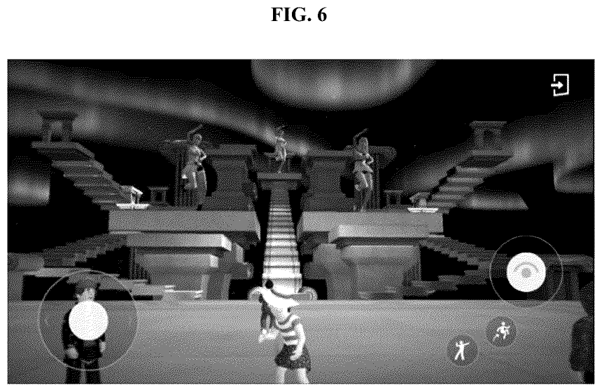

FIG. 6 illustrates an example in which a performance content provision system according to an embodiment of the present disclosure allows audience gesture information to be implemented on a user terminal.

In order to express opinions among the audience members and express responses to the performance, the performance content provision system needs to relay and synchronize gestures of the audience members. An audience member may select a gesture he or she wishes to express through his or her user terminal through a user interface (UI) shown in FIG. 6 or select a dance suitable for the corresponding performance, so that an audience avatar may perform a corresponding action and be synchronized to terminals of other audience members through the multi-play host server.

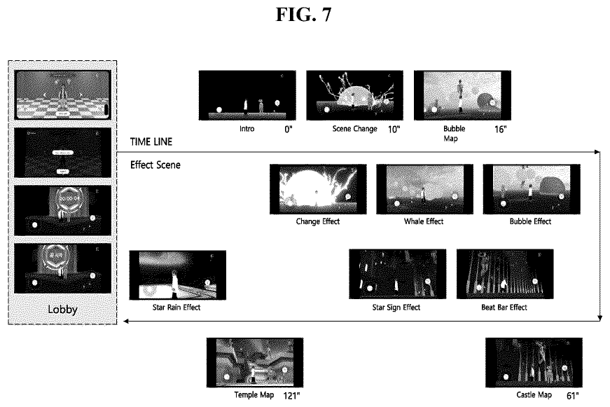

FIG. 7 illustrates an example in which a performance content provision system according to an embodiment of the present disclosure develops performance content over time.

Each audience member participating on a multi-play host server may wait in a specific waiting room called a lobby, and the performance content provision system may provide a content service in which various effects (bubble map, change effect, whale effect, etc.), including intro and scene changes, are synchronized and developed.

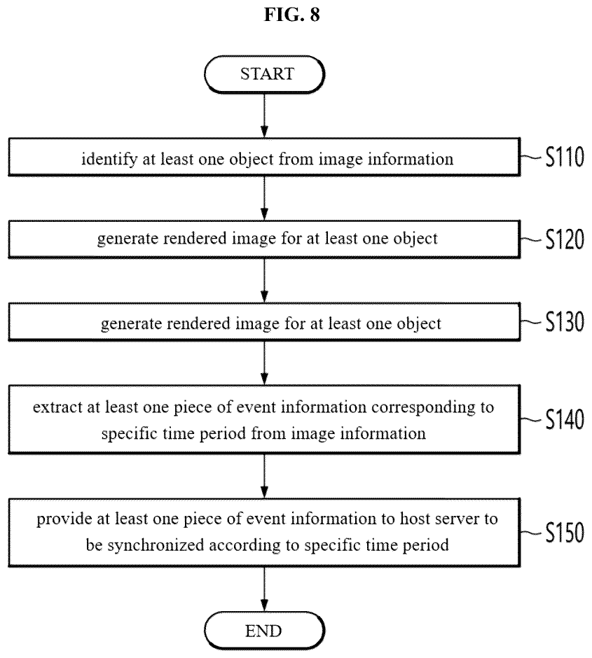

FIG. 8 is a flowchart of an operation of a performance content provision system according to an embodiment of the present disclosure.

Hereinafter, operations described as being performed by the performance content provision system may be understood as operations performed by each apparatus constituting the performance content provision system, for example, a media server, a user terminal, etc.

In operation S110, the performance content provision system identifies at least one object from image information.

More specifically, the performance content provision system may process and analyze the image information.

Further, the performance content provision system may obtain information on a captured image, perform conversion of the image in a digital format, preprocessing, and feature extraction, and identify entities included in the image.

Further, the performance content provision system may use various techniques such as machine learning, deep learning, image segmentation, feature matching, etc. to identify objects in the image. Further the performance content provision system may store information on entities identified by an entity identification module.

The performance content provision system according to the embodiment of the present disclosure may further perform a function of identifying multiple objects in the image, a function of identifying the objects in different image types and under different lighting conditions, a function of learning and improving over time, a function of providing real-time object identification, and a function of operating with different formats, such as text or audio, and different types of image sources, such as video or live camera feeds.

Here, the objects may include performers participating in a performance. More specifically, the performers may include actors or guests who make up performance content. In addition to the performers, backgrounds, props, etc. may be included in the objects of the present disclosure.

The performance content provision system may identify a region of interest for a performance creator or audience by distinguishing and identifying the objects from other components.

In operation S120, the performance content provision system generates a rendered image for at least one object.

The performance content provision system may obtain or identify data describing an entity, such as a shape, a color, and a texture, and generate a 3D representation of the object on the basis of the corresponding data. Thereafter, the performance content provision system may apply a rendering algorithm to the 3D representation to generate a final image that realistically represents the object. The rendered image may be generated as information that can be output to a display for viewing.

In operation S130, the performance content provision system transmits the rendered image to be displayed on a user terminal.

Here, the rendered image may be transmitted to the user terminal such as a computer, a smartphone, or a tablet computer and displayed on a screen. This operation may include an operation of transmitting the rendered image to the user terminal through a network such as the Internet. This operation may be used in various applications such as remote visualization, remote collaboration, or remote rendering. Accordingly, the user may access the rendered image by the apparatus being connected to the network.

The rendered image transmitted to the user terminal may be encoded in a predetermined format for streaming. In this case, the encoding operation may be performed individually by different apparatuses constituting the performance content provision system.

In operation S140, the performance content provision system extracts at least one piece of event information corresponding to a specific time period from the image information.

Here, the event information is information related to the performance and may be information other than the performance content itself. More specifically, the event information may include audience information or background information. For example, the event information may be information on special effects (e.g., fireworks) used in the performance, audience responses, etc. The event information may be understood to include all realistic experiences obtained by the audience members who participate offline at a performance site.

The event information may be extracted from the image information. However, in addition, the performance content provision system may extract or obtain the event information on the basis of acoustic information or a predetermined database.

The event information may correspond to a specific time period. More specifically the event information may correspond to at least one of the performance content itself or a time period of other event information. For example, when a fireworks event occurs at a time point at which the performer appears, the fireworks event may correspond to the time point at which the performer appears. Further, when the audience members cheer while the fireworks event occurs, the fireworks event may correspond to a time point at which the audience members cheer.

In operation S150, the performance content provision system provides at least one piece of event information to a host server to be synchronized according to the specific time period.

The performance content provision system may provide synchronized event information to the user terminal so that the user who uses the performance content can realistically experience both the event information and the performance content. Specifically, the performance content provision system may provide the extracted event information to the host server to be synchronized, and the host server may synchronize the event information and the performance content for the specific time period and then transmit the synchronized event information and performance content to the user terminal.

The host server may perform time synchronization on the event information in real time, and allow the user to immediately experience the generated event.

In the performance content provision system according to the embodiment of the present disclosure, high-definition performance content may be rendered through a separate media server and provided to the user terminal, and the event information may be time-synchronized and provided to the user terminal through a separate host server, and thus the user can experience not only high-quality content but also time-synchronized event information in a seamless environment.

The embodiments of the present disclosure described above are not only implemented through apparatuses and methods, but may also be implemented through programs that implement functions corresponding to the components of the embodiments of the present disclosure or through recording media on which the programs are recorded.

According to the present disclosure, performance elements and performances that require high performance and high quality can be rendered by a server, and rendered scenes can be transmitted in object units to a mobile device at a client side and can be synthesized and synchronized, and thus high-quality virtual reality content can be provided at a certain level of quality even on HMDs having different levels of performance and low-performance client mobile terminals other than personal computers (PCs), and interactions between audience members can be supported even in a streaming environment.

While embodiments of the present disclosure have been described above in detail, the scope of embodiments of the present disclosure is not limited thereto and encompasses several modifications and improvements by those skilled in the art using the basic concepts of embodiments of the present disclosure defined by the appended claims.

The above-described contents are specific embodiments for embodying the present disclosure. The present disclosure includes not only the above-described embodiments, but also embodiments that are simply designed or can be easily changed. Further, the present disclosure also includes techniques that can be easily modified and implemented using the embodiments. Therefore, the scope of the present disclosure is defined not by the above-described embodiment but by the appended claims, and encompasses equivalents that fall within the scope of the appended claims.

What is claimed is:

1. A method of operating a rendering server, comprising:
identifying at least one object from image information;
generating a rendered image for the at least one object;
transmitting the rendered image to be displayed on a user terminal;
extracting at least one piece of event information corresponding to a specific time period from the image information; and
providing the at least one piece of event information to a host server to be synchronized according to the specific time period.

2. The method of claim 1, wherein the image information is extracted from performance content and is visually identifiable information.

3. The method of claim 2, wherein the at least one object is at least one performer participating in the performance content.

4. The method of claim 1, wherein the at least one piece of event information is provided to the host server through a remote procedure call (RPC).

5. The method of claim 1, further comprising:
obtaining depth information corresponding to the rendered image;
generating encoded data packed according to a predetermined format on the basis of the rendered image and the depth information; and
providing the encoded data to a media server.

6. The method of claim 1, further comprising obtaining location information of the user terminal,
wherein the at least one piece of event information is synchronized according to the location information.

7. The method of claim 1, wherein the at least one piece of event information includes transform data for at least one of background information and audience information that are extracted from the image information,
the background information includes information on at least one of special effects, an animation, and an object of the image information, and
the audience information includes information on at least one of a location, a gesture, and an interaction of a user of the user terminal.

8. An apparatus of a rendering server, comprising:
a transmission and reception unit; and
at least one control unit operably connected to the transmission and reception unit,
wherein the at least one control unit is configured to identify at least one object from image information, generate a rendered image for the at least one object, transmit the rendered image to be displayed on a user terminal, extract at least one piece of event information corresponding to a specific time period from the image information, and provide the at least one piece of event information to a host server to be synchronized according to the specific time period.

9. The apparatus of claim 8, wherein the image information is extracted from performance content and is visually identifiable information.

10. The apparatus of claim 9, wherein the at least one object is at least one performer participating in the performance content.

11. The apparatus of claim 8, wherein the at least one piece of event information is provided to the host server through a remote procedure call (RPC).

12. The apparatus of claim 8, wherein the at least one control unit is further configured to obtain depth information corresponding to the rendered image, generate encoded data packed according to a predetermined format on the basis of the rendered image and the depth information, and provide the encoded data to a media server.

13. The apparatus of claim 8, wherein the at least one control unit is further configured to obtain location information of the user terminal, and
the at least one piece of event information is synchronized according to the location information.

14. The apparatus of claim 8, wherein the at least one piece of event information includes transform data for at least one of background information and audience information that are extracted from the image information,
the background information includes information on at least one of special effects, an animation, and an object of the image information, and
the audience information includes information on at least one of a location, a gesture, and an interaction of a user of the user terminal.

15. A system for providing an online performance service, comprising:
a media server;
a host server; and
a user terminal,
wherein the media server is configured to identify at least one object from image information, generate a rendered image for the at least one object, transmit the rendered image to be displayed on a user terminal, extract at least one piece of event information corresponding to a specific time period from the image information, and provide the at least one piece of event information to a host server to be synchronized according to the specific time period,
the host server is configured to obtain the at least one piece of event information from the media server, synchronize the at least one piece of event information according to the specific time period to generate event data, and provide the event data to the user terminal, and
the user terminal is configured to obtain the rendered image from the media server, obtain the event data from the host server, and display the rendered image and the event data according to the specific time period.
